(19) United States
(12) Patent Application Publication
(10) Pub. No.: US 2019/0278732 A1
(43) Pub. Date: Sep. 12, 2019

(54) STORAGE SYSTEM AND CONTROL METHOD THEREFOR

(71) Applicant: CANON KABUSHIKI KAISHA, Tokyo (JP)

(72) Inventor: Hiroki Ito, Abiko-shi (JP)

(21) Appl. No.: 16/294,671

(22) Filed: Mar. 6, 2019

(30) Foreign Application Priority Data
Mar. 8, 2018 (JP) 2018-041887

(51) Int. Cl. G06F 13/40; G06F 13/16

(52) U.S. Cl. CPC G06F 13/4027; G06F 2213/0032; G06F 13/1668

(57) ABSTRACT

A storage system includes a controller, first, second, and third bridges connected to the controller at least in part in a cascade manner, and a plurality of storage devices, each storage device connected to a bridge from among the first, second, and third bridges. At least one of the controller and the first, second and third bridges includes a memory configured to store information including a connection configuration of each of the bridges and the storage devices, a determination unit configured to determine whether the connection configuration of the bridges and the plurality of storage devices connected thereto has been changed from the connection configuration at the time of a previous operation, based on the information stored in the memory, and a re-setting unit configured to, if the connection configuration is determined to have been changed, re-set an operation mode of each of the bridges according to the change in the connection configuration.

### BACKGROUND

### Field

The present disclosure relates to a storage system and a control method therefor.

### Description of the Related Art

An information processing apparatus such as an image forming apparatus in the form of a multifunction peripheral (MFP) is equipped with a storage device for storing a program for the apparatus and image data of a user therein. Examples of the storage device include a hard disk drive (HDD) and a solid state drive (SSD).

Conventionally, a storage system has been controlled by implementing a method using, for example, Serial Advanced Technology Attachment (SATA) which has been established as an interface standard for storage devices.

For example, a control method is known in which a storage control apparatus with two HDDs connected thereto has a plurality of operation modes and the storage control apparatus transfers data while switching a transfer method by switching the operation mode.

Japanese Unexamined Patent Application Publication (Translation of PCT Application) No. 2011-515749 discusses a control method for connecting, to a SATA bridge connected to a main controller on a host side and functioning as a port multiplier on a device side, further SATA bridges at a plurality of stages in a cascade manner to expand the functionality of the port multiplier.

In a storage system having a plurality of operation modes and including the SATA bridges connected in the cascade manner as discussed in Japanese Unexamined Patent Application Publication (Translation of PCT Application) No. 2011-515749, for example, any of a plurality of storage devices connected to the storage system further beyond the SATA bridge(s) may be replaced with another storage device. In this case, maintaining the same operation mode of the SATA bridge as before the replacement may result in an operation mode that is incompatible with the storage device connected to the storage system after the replacement. Further, the operation mode of the SATA bridges connected in the cascade manner may also become incompatible with the new storage device connected to the storage system after the replacement.

If a mismatch occurs between the operation mode of a bridge and the storage device connected to the bridge in this manner, the bridge becomes unable to operate normally. Further, a mismatch may also occur in the operation mode among the bridges connected in the cascade manner, and such a mismatch may also result in a failure to continue normal operations.

### SUMMARY

The present disclosure is directed to a storage system and a control method having a configuration described below to solve the above-described problem.

According to various embodiments of the present disclosure, a storage system includes a controller, a first bridge connected to the controller, a second bridge and a third bridge connected to the first bridge, a plurality of storage devices each connected to the second bridge or the third bridge, a memory configured to store information including a connection configuration of the plurality of storage devices, a determination unit configured to determine whether the connection configuration of the plurality of storage devices has been changed, based on the information stored in the memory, and a re-setting unit configured to re-set at least one of an operation mode of the first bridge, an operation mode of the second bridge, or an operation mode of the third bridge based on the connection configuration after the change, based on the determination that the connection configuration has been changed.

Further features will become apparent from the following description of exemplary embodiments with reference to the attached drawings.

### BRIEF DESCRIPTION OF THE DRAWINGS

FIG. 1 is a block diagram illustrating a configuration of an entire information processing apparatus.

FIG. 2 is a block diagram illustrating a detailed configuration of a main controller according to an exemplary embodiment.

FIG. 3 is a block diagram illustrating a detailed configuration of a bridge according to the exemplary embodiment.

FIG. 4 is a block diagram illustrating detailed configurations of bridges connected in a cascade manner according to the exemplary embodiment.

FIG. 5 is a state transition diagram illustrating a state transition of the bridge according to the exemplary embodiment.

FIGS. 6A and 6B are a flowchart of initialization processing performed by the main controller according to the exemplary embodiment, and a flowchart of initialization processing performed by the bridge according to the exemplary embodiment.

FIGS. 7A and 7B are a flowchart of mode re-setting processing performed by the main controller according to the exemplary embodiment, and a flowchart of mode re-setting processing performed by the bridge according to the exemplary embodiment.

### DESCRIPTION OF THE EMBODIMENTS

An exemplary embodiment of the present disclosure will be described below in detail with reference to the drawings by way of example. However, components and features that are described in this exemplary embodiment are merely cited as examples, and are not intended to limit the scope of the present invention only to embodiments which include these components or features.

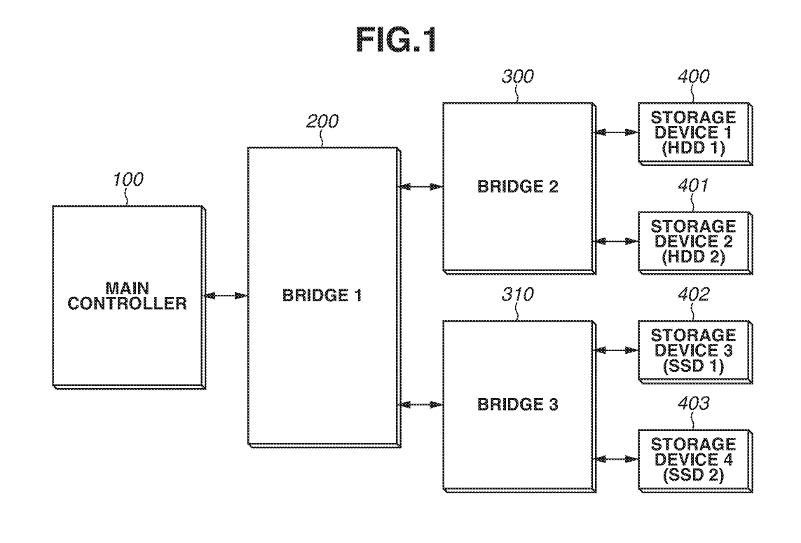

FIG. 1 is a block diagram illustrating a configuration of an entire information processing apparatus including a storage system according to a first exemplary embodiment of the present disclosure. The present exemplary embodiment will be described based on an example in which the present exemplary embodiment is applied to an image forming apparatus such as a multifunction peripheral (MFP) as one example of the information processing apparatus, but is not limited thereto and can be applied to an information processing apparatus configured to include a plurality of storage devices. Especially, the present exemplary embodiment can be effectively applied to an information processing apparatus configured to include bridges connected in a cascade manner and a plurality of storage devices connected to them.

The information processing apparatus according to the present exemplary embodiment illustrated in FIG. 1 includes a main controller 100, a plurality of storage devices storing data therein, such as four storage devices 400, 401, 402, and 403, and a plurality of bridges, such as three bridges 200, 300, and 310. The bridges 200, 300, and 310 transmit and receive data to and from these storage devices 400, 401, 402, and 403. The main controller 100 controls the entire information processing apparatus, and also controls an MFP therein.

In the present exemplary embodiment, the storage device 1 (400) and the storage device 2 (401) are each a first type storage device having a function of storing data not requiring a high access speed, e.g, a nonvolatile storage device including a disk in the present exemplary embodiment. In other words, the first type storage device is a nonvolatile storage device involving disk access, and is, for example, a hard disk drive (HDD: HDD 1 and HDD 2). Further, the storage device 3 (402) and the storage device 4 (403) are each a second type storage device having a function of storing data requiring a high access speed therein, e.g., a nonvolatile storage device including a semiconductor memory in the present exemplary embodiment. In other words, the second type storage device is a storage device including a semiconductor flash memory, such as a solid state drive (SSD), and is assumed to be an SSD (an SSD 1 and an SSD 2) in the present exemplary embodiment. However, the first type storage device and the second type storage device are not limited to the HDD and the SSD, respectively. Further, the definitions concerning the first type storage device and the second type storage device are also merely examples, and the storage devices are not limited to these examples.

Further, the number of bridges is assumed to be three in the present exemplary embodiment, but the number is not limited thereto and the present exemplary embodiment can also support a configuration in which at least one of the bridges 300 and 310 is removed and/or a not-illustrated bridge is further additionally connected.

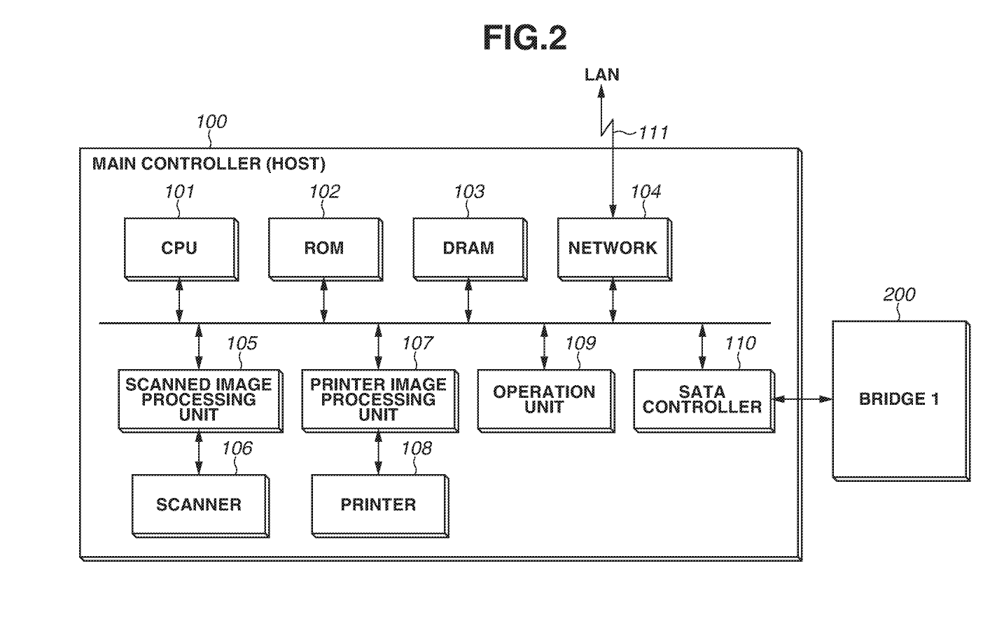

FIG. 2 illustrates a specific configuration example of the main controller 100 serving as a host.

The main controller 100 includes a central processing unit (CPU) 101, a read only memory (ROM) 102, a dynamic random access memory (DRAM) 103, various kinds of image processing units, such as a scanned image processing unit 105 and a printer image processing unit 107, a scanner 106, a printer 108, and an operation unit 109. These components form the MFP. The main controller 100 further includes a Network 104 and a Serial Advanced Technology Attachment (SATA) controller 110.

The CPU 101 has a function to control the main controller 100 and the entire information processing apparatus, and executes system control, calculation processing, an operating system (OS), and an application.

The ROM 102 is a read-only memory, and stores a control program to be executed by the CPU 101 and setting information. The DRAM 103 stores the control program executed by the CPU 101, and also functions as a temporary work area. The Network 104 is a network interface (I/F), and transmits image data subjected to image processing in the MFP to an external information apparatus (not illustrated) via a local area network (LAN) 111. Alternatively, the Network 104 inputs image data from the external information apparatus.

The scanner 106 is an image input device. The scanner 106 acquires raster image data by irradiating an image on paper set as an original document with light and scanning it with a charge coupled device (CCD) line sensor (not illustrated), and converts the acquired data into an electric signal and then outputs it.

The scanned image processing unit 105 performs image processing on the image data of the electric signal that is received from the scanner 106. The image data subjected to the image processing is stored into any of the storage devices 400 to 403 via the SATA controller 110, the bridge 200.

The printer image processing unit 107 performs image processing on the received image data, and transmits the image data subjected to the image processing to the printer 108. The printer 108 is an image output device, and prints the received image data (e.g., raster image data) on a sheet as an image.

The operation unit 109 is a user interface device, such as a touch panel having both a display function and an operation function. The operation unit 109 has a function of displaying the image data input to the main controller 100, a function of notifying the CPU 101 of information input by a system operator (a user), and the like.

The SATA controller 110 controls a device connected to the SATA controller 110, such as the bridge 200, in compliance with the SATA standard, and transmits and receives data to and from the bridge 200 and the like, under control by the CPU 101.

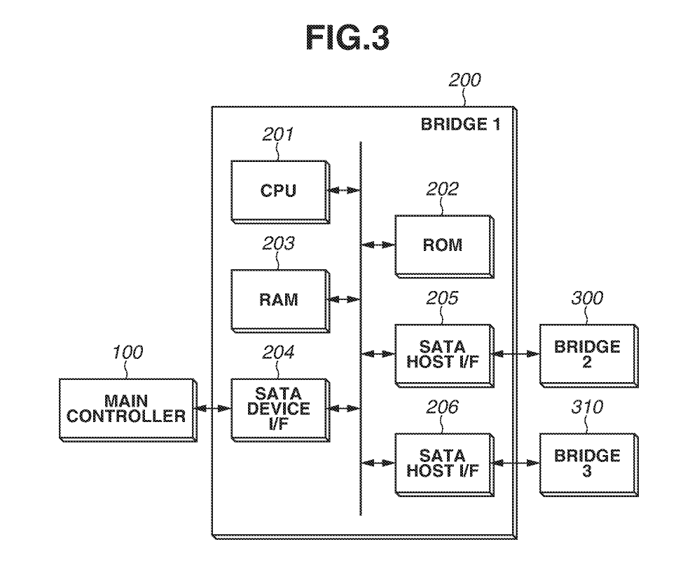

FIG. 3 illustrates a detailed configuration example of the bridge 200.

A CPU 201 of the bridge 200 performs system control, calculation processing, ATA command processing, and the like in the bridge 200, and also performs, for example, processing of a transmission command directed to the storage devices 400 to 403 and the bridges 300 and 310. A ROM 202 stores a control program to be executed by the CPU 201 and data of setting values of various kinds of modes. A RAM 203 stores the control program to be executed by the CPU 201, and also functions as a temporary work area.

A SATA device I/F 204 is connected to the main controller 100, and communicates with the SATA controller 110 in the main controller 100 in compliance with the SATA standard. SATA host I/Fs 205 and 206 are respectively connected to the bridges 300 and 310 and communicate with the bridges 300 and 310 in compliance with the SATA standard.

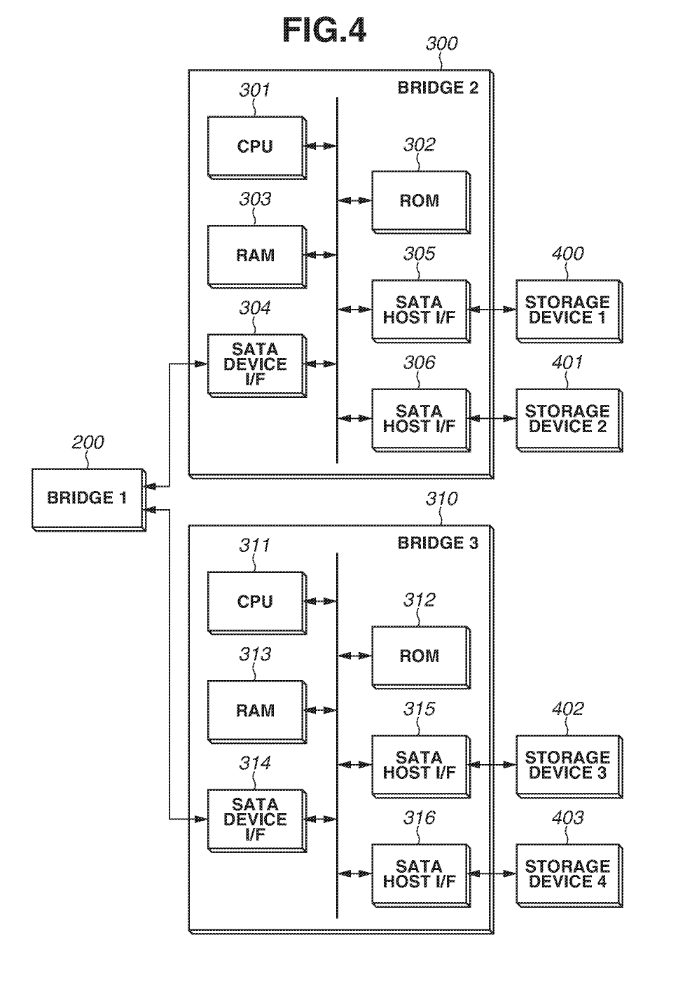

FIG. 4 illustrates detailed configuration examples of the bridge 200 and the bridge 300 connected in a cascade manner, and the bridge 310 also connected to the bridge 200 in the cascade manner. The bridges 200, 300, and 310 will be described assuming that they have a same configuration, but embodiments of the present disclosure are not limited to these configurations. Needless to say, a function may be added or removed in a part of the bridges 200, 300, and 310 within a range that remains within the scope of the present disclosure.

A CPU 301 of the bridge 300 performs system control, calculation processing, and ATA command processing, and also performs, for example, processing of a transmission command directed to the storage device 400 and the storage device 401. A ROM 302 stores a control program to be executed by the CPU 301 and data of setting values of the various kinds of modes. A RAM 303 stores the control program to be executed by the CPU 301, and also functions as a temporary work area.

A SATA device I/F 304 is connected to the bridge 200, and communicates with the SATA host I/F 205 in the bridge 200 in compliance with the SATA standard.

SATA host IfFs 305 and 306 are connected to devices, i.e., the storage devices 400 and 401 in the present exemplary embodiment, and communicate with the storage devices 400 and 401 in compliance with the SATA standard, respectively.

Similarly, a CPU 311 of the bridge 310 performs system control, calculation processing, and ATA command processing, and also performs, for example, processing of a transmission command directed to the storage device 402 and the storage device 403. A ROM 312 stores a control program of the CPU 311 and data of setting values of the various kinds of modes therein. A RAM 313 stores the control program executed by the CPU 311 therein, and also functions as a temporary work area.

A SATA device I/F 314 is connected to the bridge 200, and communicates with the SATA host I/F 206 in the bridge 200 in compliance with the SATA standard.

SATA host I/Fs 315 and 316 are respectively connected to devices, i.e., the storage devices 402 and 403 in the present exemplary embodiment, and communicate with the storage devices 402 and 403 in compliance with the SATA standard.

The bridges 200, 300, and 310 will be described as SATA bridges connected via SATA interfaces in the present exemplary embodiment, but embodiments of the present disclosure are not limited to these configurations. Each of the bridges 200, 300, and 310 may be another interface, such as Peripheral Component Interconnect Express (PCIE).

Further, the SATA controller 110 and the bridges 200, 300, and 310 will be described assuming that they are configured on different chips individually in the present exemplary embodiment, but embodiments of the present disclosure are not limited to these configurations. For example, any two or more of the SATA controller 110 and the bridges 200, 300, and 310 may be configured to be included in the same chip in other embodiments of the present disclosure.

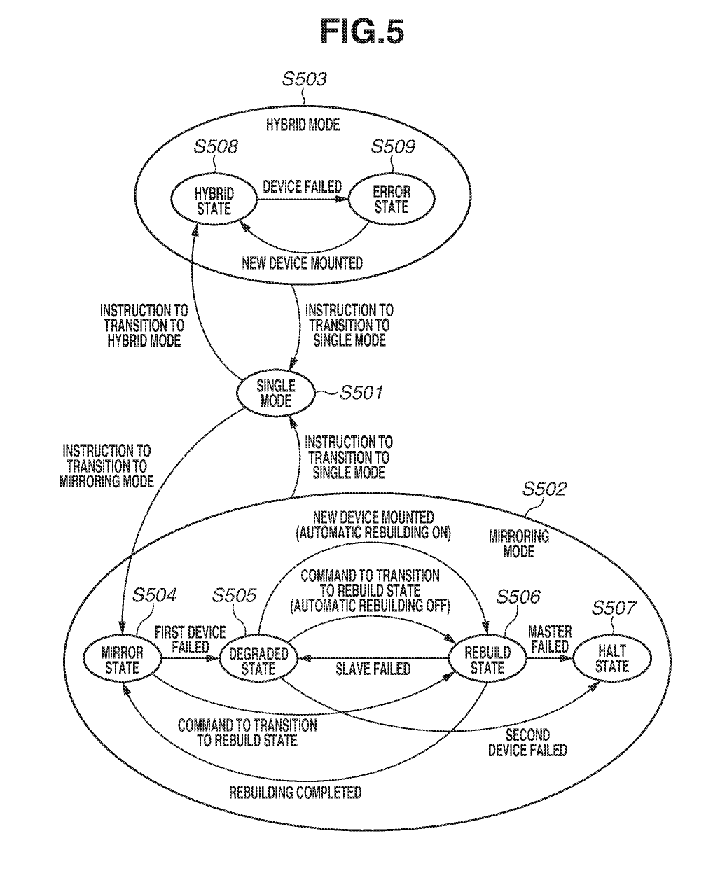

FIG. 5 is a state transition diagram illustrating a state transition of each of the bridges 200, 300, and 310 according to the first exemplary embodiment.

Now, an operation of each of the bridges 200, 300, and 310 will be described with reference to FIG. 5.

This operation will be described with reference to FIG. 4 focusing on the operation of the bridge 300 as a representative example, but the other bridges 200 and 310 also operate in a similar manner. Further, this operation will be described assuming that the HDDs are used as the storage devices 400 and 401 connected to the bridge 300.

Each of the bridges 200, 300, and 310 has three operation modes, i.e., a single mode (S501), a mirroring mode (S502), and a hybrid mode (S503).

The single mode (S501) is a mode in which the bridge operates with the HDD mounted only on one SATA host I/F thereof. In a case of the bridge 300, the single mode (S501) is a mode in which the bridge 300 operates with the HDD connected to only any one of the SATA host I/F 305 and the SATA host I/F 306.

The CPU 301 transitions to a mirror state (S504) if receiving a transition command to the mirroring mode (S502) from the host side (bridge 200 side) via the SATA device I/F 304 in the single mode (S501).

Further, the CPU 301 transitions to a hybrid state (S508) if receiving a transition command to the hybrid mode (S503) from the host side via the SATA device I/F 304 in the single mode (S501).

When transitioning to each of the states, the CPU 301 stores the state to which the CPU 301 has transitioned into the ROM 302. The single mode (S501) is a default operation mode, and the CPU 301 starts operating in the single mode (S501) if the mode at the time of a previous operation (at the time of initialization such as a startup or at the time of access to the device) is not stored in the ROM 302 upon a startup.

Alternatively, if the mode at the time of the previous operation is stored in the ROM 302 upon the startup, the CPU 301 starts operating in this stored operation mode.

The mirroring mode (S502) is a mode in which the bridge 300 operates with the HDD mounted on each of the two SATA host IFs 305 and 306.

The mirroring mode (S502) includes four states, i.e., the mirror state (S504), a degraded state (S505), a rebuild state (S506), and a halt state (S507).

In the mirroring mode (S502), the CPU 301 treats one of the HDDs respectively connected to the two SATA host I/Fs 305 and 306 as a master HDD, and the other of them as a slave HDD.

The mirror state (S504) is a state in which both the HDDS are in normal operation with the HDDs mounted on the two SATA host I/Fs 305 and 306.

In the mirror state (S504), if receiving a command to read out data from the host side via the SATA device I/F 304, the CPU 301 executes this command, targeting only the master HDD of the HDDs connected to the SATA host I/Fs 305 and 306.

In the mirror state (S504), if receiving a data write command from the host side via the SATA device I/F 304, the CPU 301 executes this command, targeting the HDDs connected to the SATA host I/Fs 305 and 306. In other words, the CPU 301 executes this command, targeting both the master HDD and the slave HDD.

The CPU 301 transitions to the degraded state (S505) if an abnormality such as a failure has occurred in any one of the master HDD and the slave HDD in the mirror state (S504).

The CPU 301 transitions to the rebuild state (S506) if receiving a transition command to the rebuild state (S506) from the host side via the SATA device I/F 304 in the mirror state (S504).

The degraded state (S505) is a state in which the CPU 301 detects an abnormality such as a failure in the HDD connected to one of the SATA host I/Fs and stops the access to this HDD, and is in operation with use of only the normal HDD connected to the other of the SATA host I/Fs.

The CPU 301 transitions to the rebuild state (S506) if detecting that a normal HDD is newly connected to the SATA host I/F instead of the failed HDD in the degraded state (S505).

The CPU 301 transitions to the halt state (S507) if detecting that both of the HDDs connected to the SATA host I/Fs 305 and 306 are abnormal in the degraded state (S505). This situation corresponds to a case, for example, in which the HDD connected to the other of the SATA host I/Fs 305 and 306 has also failed.

The rebuild state (S506) is a state in which the bridge is in operation with use of only one of the HDDs (the HDD that has been mounted since before the failure and has not failed), but is a state in which the bridge is copying (rebuilding) the data to the other of the HDDs (HDD newly mounted instead of the failed HDD).

At this time, the CPU 301 treats the HDD from which the data is copied (the HDD that has been mounted since before the failure and has not failed) as the master HDD, and the HDD to which the data is copied (the HDD newly mounted instead of the failed HDD) as the slave HDD.

The CPU 301 transitions to the mirror state (S504) if the rebuilding is completed in the rebuild state (S506). The CPU 301 transitions to the degraded state (S505) if the slave HDD has failed in the rebuild state (S506). On the other hand, the CPU 301 transitions to the halt state (S507) if the master HDD has failed in the rebuild state (S506).

The halt state (S507) is a state in which the bridge becomes unable to continue the mirroring operation because both of the HDDs are brought into an abnormal state.

The HDDs have been cited as examples of the devices connected to the SATA host I/Fs 305 and 306 in the present exemplary embodiment, but the same also applies to a case in which the connected devices are SSDs or bridges.

In a case where the devices connected to the SATA host I/Fs 305 and 306 are the SSDs, the CPU 301 determines that an abnormal device is connected when the SSD itself, for example, has failed, similar to a case where the connected devices are the HDDs.

In a case where the devices connected to the SATA host I/Fs 305 and 306 are the bridges, the CPU 301 determines that an abnormal device is connected when being notified that this bridge is in an abnormal state due to, for example, a failure.

The hybrid mode (S503) is a mode in which the CPU 301 operates in such a state that different types of storage devices, in particular, an HDD and an SSD in the present example are mounted on the two SATA host I/Fs 305 and 306.

The hybrid mode (S503) includes two states, i.e., the hybrid state (S508) and an error state (S509).

In the hybrid mode (S502), the CPU 301 integrates addresses with respect to the HDD and the SSD connected to the two SATA host I/Fs 305 and 306, and operates so as to cause them to appear as if they are one storage device as viewed from the host side via the SATA device/F 304.

The hybrid state (S508) is a state in which, with the HDD and the SSD mounted on the two SATA host I/Fs 305 and 306, these HDD and SSD are in normal operation.

The CPU 301 transitions to the error state (S509) if an abnormality such as a failure has occurred in any one of the HDD and the SSD in the hybrid state (S508).

The error state (S509) is a state in which the bridge becomes unable to continue the hybrid operation because any one of the HDD and the SSD is brought into an abnormal state.

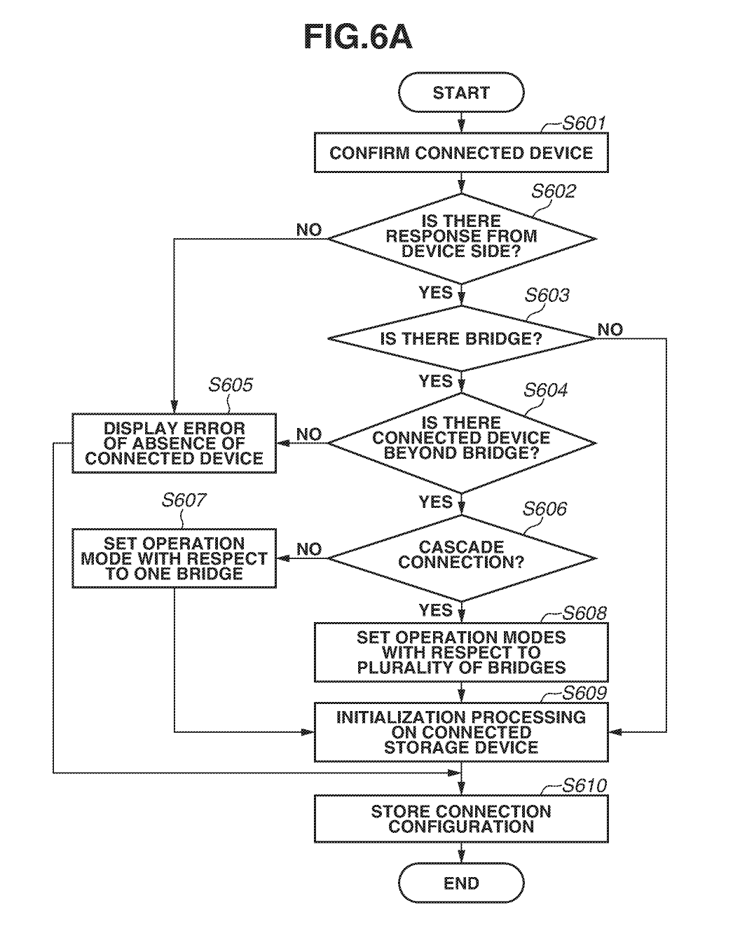

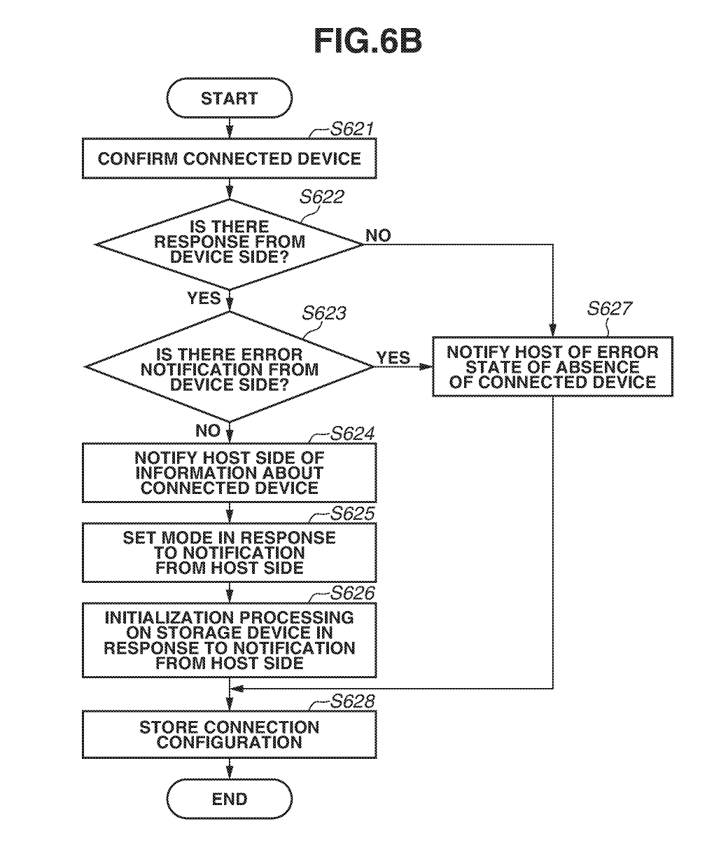

Initialization processing targeting the SATA device connected to the SATA controller 110 that is performed by the CPU 101 in the main controller 100 according to the present exemplary embodiment will be described with reference to a flowchart illustrated in FIG. 6A.

A program running on the CPU 101 regarding the flowchart illustrated in FIG. 6A may be stored in the DRAM 103, the ROM 102, or any of the storage devices 400 to 403.

The initialization processing will be described assuming that the CPU 101 in the main controller 100 performs this processing in the present exemplary embodiment, but the present processing may be set so as to be performed by any of the bridges 200, 300, and 310.

The processing illustrated in the flowchart of FIG. 6A will be described assuming that this processing is performed at the time of the initialization such as the startup, but is not limited thereto. This processing procedure may be performed when the CPU 101 accesses the SATA device connected to the SATA controller 110, for example, every time the CPU 101 attempts this access.

First, in step S601, the CPU 101 confirms whether there is a device connected to the SATA controller 110, in this case, whether a SATA device is connected to the device side via the SATA controller 110. As a specific example thereof, the CPU 101 issues an ATA command such as an IDENTIFY DEVICE command to the device side via the SATA controller 110, thereby confirming whether a SATA device is connected. In other words, the CPU 101 transmits a notification for confirming whether there is a connected device to the device side via the SATA controller 110.

If there is a response to the IDENTIFY DEVICE command issued in step S601 from the device side via the SATA controller 110 (YES in step S602), the CPU 101 determines that a device is connected to the SATA controller 110. In other words, the CPU 101 determines that a SATA device is connected to the SATA controller 110, and the processing proceeds to step S603.

On the other hand, if there is no response to the IDENTIFY DEVICE command from the device side (NO in step S602), the CPU 101 determines that no device is connected to the SATA controller 110, i.e., no SATA device is connected, and the processing proceeds to step S605. In step S605, the CPU 101 presents an error display on the operation unit 109, indicating that no device is connected to the SATA controller 110. After that, the processing may proceed to step S610, and the CPU 101 may operate so as to store information acquired in step S602 into the ROM 102.

In step S603, the CPU 101 determines whether a bridge is connected to the SATA controller 110 as the SATA device based on a content of the response to the IDENTIFY DEVICE command issued in step S601.

In step S603, if the CPU 101 determines that a bridge (the bridge 200 in the specific example illustrated in FIG. 2) is connected to the SATA controller 110 (YES in step S603), the processing proceeds to step S604.

On the other hand, if the CPU 101 determines that not the bridge but a storage device is connected to the SATA controller 110 in step S603 (NO in step S603), the processing proceeds to step S609. In step S609, the CPU 101 performs initialization processing, which will be described below, on this storage device.

In step S604, the CPU 101 determines whether there is further a connected device beyond the bridge 200 connected to the SATA controller 110 based on the content of the response to the IDENTIFY DEVICE command issued in step S601.

If the CPU 101 determines that there is further a connected device beyond the bridge 200 in step S604 (YES in step S604), the processing proceeds to step S606. If the CPU 101 determines that there is no connected device in step S604 (NO in step S604), the processing proceeds to step S605.

The content of the response to the IDENTIFY DEVICE command contains whether there is a connected device, and, if there is a connected device, also contains information about this connected device together therewith. More specifically, as the connected device, the content of the response contains setting information and the operation mode of each of the bridges 300 and 310, a connection relationship (also referred to as a connection configuration) among the bridges 300 and 310 and the storage devices 400 to 403 connected thereto, the type of each of the storage devices 400 to 403 in the specific example illustrated in FIG. 1.

In step S605, the CPU 101 presents an error display on the operation unit 109, indicating that a device connected to the bridge 200 or beyond the bridge 200 cannot be detected. Then, the processing proceeds to step S610. In step S610, the CPU 101 stores, for example, the setting information of the bridge 200 acquired from the connected device information contained in the content of the response to the IDENTIFY DEVICE command into the ROM 102 as connection configuration information.

In step S606, the CPU 101 determines whether a bridge is connected to the SATA controller 110 in the cascade manner based on the content of the response to the IDENTIFY DEVICE command issued in step S601. In this case, examples of a bridge being connected in the cascade manner include when at least one of the bridges 300 and 310 is connected beyond the bridge 200 as illustrated in FIG. 1.

In step S606, if the CPU 101 determines that a bridge is connected to the SATA controller 110 in the cascade manner (YES in step S606), the processing proceeds to step S608.

On the other hand, in step S606, if the CPU 101 determines that only the bridge 200 is connected to the SATA controller 110 and no cascade connection is established (NO in step S606), the processing proceeds to step S607.

In step S607, the CPU 101 re-sets the operation mode of the bridge 200 by transmitting a mode setting instruction to the bridge 200 via the SATA controller 110 based on the connected device information contained in the content of the response from the device side. More specifically, the CPU 101 determines the operation mode of each bridge based on the connection relationship (connection configuration) between each bridge and each storage device and the type of each storage device that are contained in the connected device information, and sets the determined operation mode to each bridge. At this time, the operation mode set to the bridge 200 is either the mirroring mode S502 or the hybrid mode S503.

As a specific example, the CPU 101 sets the mirroring mode S502 if two storage devices connected to the bridge 200 are the same type of storage devices (e.g., HDDs or SSDs). On the other hand, the CPU 101 sets the hybrid mode S503 if the two storage devices connected to the bridge 200 are different types of storage devices (e.g., an HDD and an SSD).

Then, the processing proceeds to step S609. In step S609, the CPU 101 transmits an initialization processing instruction targeting the connected storage device from the SATA controller 110 to the bridge 200, thereby performing the initialization processing on the storage device.

Needless to say, the CPU 101 may operate so as to re-set the single mode S501 if only one storage device is connected to the bridge 200.

In step S608, the CPU 101 transmits the mode setting instruction to each of the bridges connected in the cascade manner via the SATA controller 110, thereby re-setting the operation mode of each of the bridges. In the present exemplary embodiment, assume that the three bridges 200, 300, and 310 are connected in the cascade manner, and the two storage devices are connected to each of the bridges 300 and 310 as illustrated in FIG. 1. At this time, the operation modes set to the bridges 200, 300, and 310 are both the mirroring mode S502 and the hybrid mode S503.

As a specific example, the CPU 101 sets the mirroring mode S502 to the bridge 300 if both the two storage devices 400 and 401 connected to the bridge 300 are the first type storage devices (HDD 1 and HDD 2), which are the same type of storage devices, like the configuration illustrated in FIG. 1. Similarly, the CPU 101 sets the mirroring mode S502 to the bridge 310 if both the two storage devices 402 and 403 connected to the bridge 310 are the second type storage devices (SSD 1 and SSD 2), which are the same type of storage devices. Therefore, in this case, the CPU 101 sets the hybrid mode S503 to the bridge 200.

As another specific example, the CPU 101 sets the hybrid mode S503 to each of the bridges 300 and 310 if the two storage devices connected to each of the bridges 300 and 310 are the different types of storage devices, such as the HDD and the SSD. Thus, in this case, the CPU 101 sets the mirroring mode S502 to the bridge 200. In this manner, matching is maintained between the operation modes of the bridges 200, 300, and 310 and the combinations of the storage devices connected to them.

In step S609, the CPU 101 transmits the initialization processing instruction targeting the storage devices 400 to 403 connected to the bridges 300 and 310 from the SATA controller 110 to the bridge 200, thereby performing the initialization processing on the storage devices 400 to 403.

Next, in step S610, the CPU 101 stores, as the connection configuration information, information about the connected device(s) connected beyond the SATA controller 110 that is contained in the content of the response to the IDENTIFY DEVICE command from the device side. At this time, the connection configuration information refers to the connection relationship (connection configuration) between each of the bridges and the storage devices, the type of each of the storage devices, the operation mode and the setting information of each of the bridges, and the like, and is stored into the ROM 102 or any of the storage devices 400 to 403.

In the present exemplary embodiment, the example using the IDENTIFY DEVICE command has been described as the method for confirming the connected device configuration. However, the method for confirming the device configuration is not limited thereto, and any method may be employed as long as the employed method allows the CPU 101 to confirm whether there is a SATA device and the like, confirm whether there is a bridge and the like, and whether bridges are connected in the cascade manner and the like. Further, the method for confirming the connected device configuration is not limited to the ATA command, and an expansion command or the like may be issued.

Next, initialization processing performed by each of the bridges 200, 300, and 310 on the SATA devices connected to them according to the present exemplary embodiment will be described with reference to a flowchart illustrated in FIG. 6B.

In the present exemplary embodiment, initialization processing performed by the CPU 201 in the bridge 200 will be described as one example, but the present processing is also performed by the other bridges 300 and 310 in a similar manner.

A program running on the CPU 201 regarding the flowchart illustrated in FIG. 6B may be stored in the RAM 203, the ROM 202, or any of the storage devices 400 to 403.

The processing illustrated in the flowchart of FIG. 6B will be described assuming that this processing is performed at the time of the initialization such as the startup, but is not limited thereto and may be performed when the CPU 201 accesses the SATA device connected to the bridge, for example, every time the CPU 201 attempts this access.

First, in step S621, the CPU 201 receives the notification for confirming whether there is a connected device from the host side (SATA controller 110) via the SATA device I/F 204. Then, the CPU 201 confirms whether a SATA device is connected beyond the SATA host I/Fs 205 and 206. As a specific example, the CPU 201 issues an ATA command such as an IDENTIFY DEVICE command to the device side via each of the SATA host I/Fs 205 and 206, thereby confirming whether a SATA device is connected.

If there is a response to the IDENTIFY DEVICE command issued in step S621 from the device side via the SATA host I/Fs 205 and 206 (YES in step S622), the CPU 201 determines that there is a SATA device beyond the SATA host I/Fs 205 and 206. After that, the processing proceeds to step S623.

On the other hand, if there is no response to the IDENTIFY DEVICE command issued in step S621 from the device side (NO in step S622), the CPU 201 determines that no device is connected to the SATA host I/Fs 205 and 206. In other words, the CPU 201 determines that no SATA device is connected to the SATA host I/Fs 205 and 206, and the processing proceeds to step S627.

In step S623, the CPU 201 determines whether an error notification indicating that no device is connected to the SATA host I/Fs 205 and 206 is contained in the response to the IDENTIFY DEVICE command issued in step S621 from the device side. In step S623, if the CPU 201 determines that the error notification is contained in the response to the IDENTIFY DEVICE command from the device side (YES in step S623), the processing proceeds to step S627.

On the other hand, in step S623, if the CPU 201 determines that the error notification is not contained in the response to the IDENTIFY DEVICE command from the device side (NO in step S623), the processing proceeds to step S624.

In step S627, the CPU 201 notifies the host side that the current state is such an error state that no device is connected to the SATA host I/Fs 205 and 206. With this notification, the main controller 100 presents the error display on the operation unit 109, indicating that no device is connected to the SATA host I/Fs 205 and 206. After that, the processing may proceed to step S628, and the CPU 201 may operate so as to store the information about the connected device acquired in step S622 into the ROM 202 as the connection configuration information.

In step S624, the CPU 201 acquires the information about the connected devices by merging the content of the response to the IDENTIFY DEVICE command issued in step S621 from the device side and information about the bridge 200 itself. In step S624, the CPU 201 further returns the connected device information to the host side via the SATA device I/F 204.

The content of the response from the device side contains the connected device information of the SATA device connected to the bridge 200, i.e., the setting information of the bridges 300 and 310, the connection configuration and the types of the storage devices 400 to 403 connected to these bridges 300 and 310, in the example illustrated in FIG. 1.

After that, in step S625, the CPU 201 receives the mode setting instruction from the host side responding to the connected device information that the host side has been notified of via the SATA device I/F 204.

Further, the CPU 201 identifies a content of a mode setting instruction addressed to the bridge 200 and contents of mode setting instructions addressed to the devices connected to the SATA host I/Fs 205 and 206 (addressed to the bridges 300 and 310 in the specific example illustrated in FIG. 1) based on the received mode setting instruction.

Next, in step S625, the CPU 201 sets the operation mode of the bridge 200 itself according to the identified mode setting instruction addressed to the bridge 200. Further, the CPU 201 notifies the bridges 300 and 310 of the contents of the identified mode setting instructions addressed to the devices connected to the SATA host I/Fs 205 and 206 via the SATA host I/Fs 205 and 206. By this notification, the operation modes of the bridges 300 and 310 are set according to these mode setting instructions.

After that, in step S626, the CPU 201 receives the initialization processing instruction targeting the storage devices 400 to 403 from the host side via the SATA device I/F 204. Then, the CPU 201 notifies the devices connected to the SATA host I/Fs 205 and 206 of the received initialization processing instruction. In response to this notification, the initialization processing is performed on the storage devices 400 to 403 connected to the bridges 300 and 310.

Next, in step S628, the CPU 201 stores the operation mode of the bridge 200 that has been set in step S625 and the information about the connected devices that has been acquired in step S622 into the ROM 202 as the connection configuration information.

In this manner, the initialization processing in the bridge 200 is ended.

The initialization processing is also performed in the other bridges 300 and 310 connected to the bridge 200 in a similar manner.

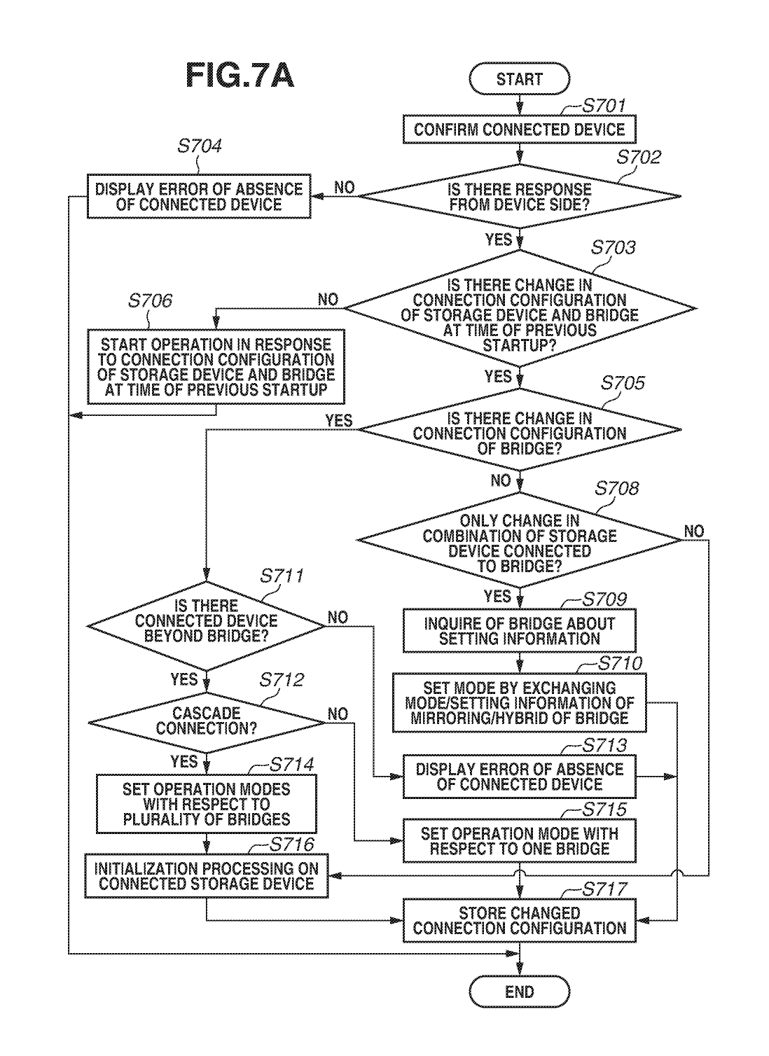

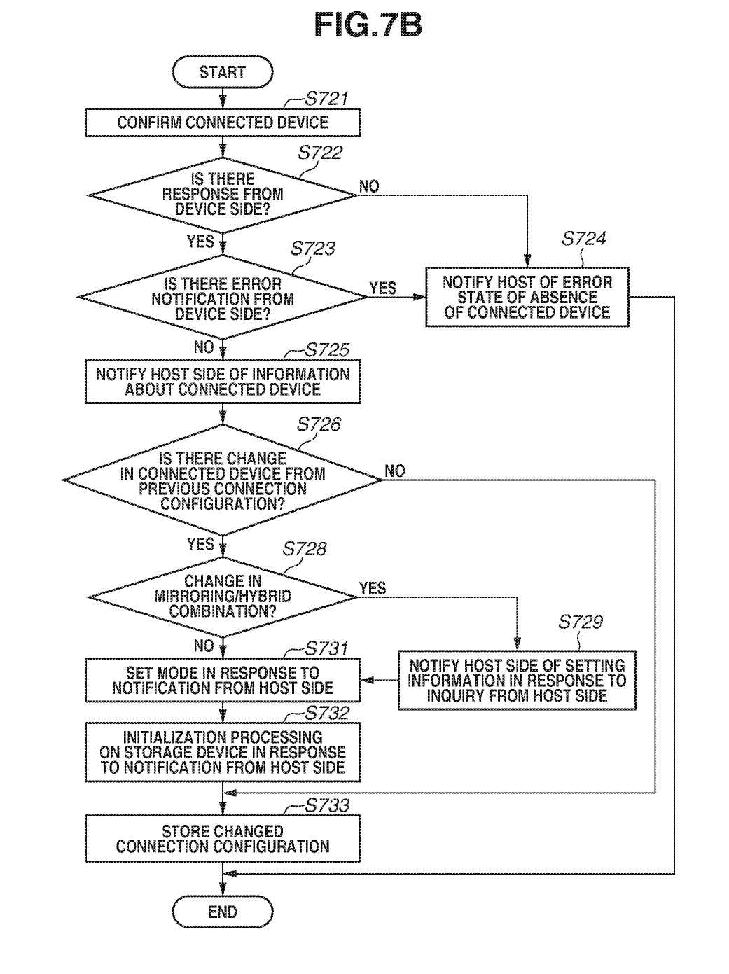

Processing for re-setting the mode of the device connected to the SATA controller 110 that is performed by the CPU 101 in the main controller 100 according to the present exemplary embodiment will be described with reference to a flowchart illustrated in FIG. 7A.

A program running on the CPU 101 regarding the flowchart illustrated in FIG. 7A may be stored in the DRAM 103, the ROM 102, or any of the storage devices 400 to 403.

The mode re-setting processing according to the present flowchart will be described assuming that the CPU 101 in the main controller 100 performs this processing in the present exemplary embodiment, but the present processing may be set so as to be performed by any of the bridges 200, 300, and 310.

The processing procedure illustrated in FIG. 7A will be described assuming that this processing is performed at the time of the initialization such as the startup in the present exemplary embodiment, but is not limited thereto and may be performed when the CPU 101 accesses the connected SATA device, for example, every time the CPU 101 attempts this access.

First, in step S701, the CPU 101 issues the ATA command such as the IDENTIFY DEVICE command to the device side via the SATA controller 110, thereby confirming whether a SATA device is connected. In other words, the CPU 101 transmits a notification for confirming whether there is a connected device to the device side and the like via the SATA controller 110.

If there is a response to the IDENTIFY DEVICE command issued in step S701 from the device side (YES in step S702), the CPU 101 determines that a device is connected to the SATA controller 110. In other words, the CPU 101 determines that a SATA device is connected to the SATA controller 110, and the processing proceeds to step S703.

On the other hand, if there is no response to the IDENTIFY DEVICE command issued in step S701 from the device side (NO in step S702), the CPU 101 determines that no device is connected to the SATA controller 110. In other words, the CPU 101 determines that no SATA device is connected to the SATA controller 110, and the processing proceeds to step S704.

In step S704, the CPU 101 presents an error display on the operation unit 109, indicating that no device is connected to the SATA controller 110, i.e., no SATA device can be detected on the device side. Then, the CPU 101 ends the processing. The CPU 101 may operate so as to end the processing after storing the information acquired in step S702 into the ROM 102.

In step S703, the CPU 101 compares the content of the response to the IDENTIFY DEVICE command issued in step S701 from the device side and the connection configuration at the time of the previous startup that has been stored into the ROM 102 or the like during the initialization processing illustrated in FIG. 6A. In the present exemplary embodiment, assume that the connection configuration at the time of the previous startup that has been stored in the ROM 102 or the like indicates the connection configuration among the bridges 200, 300, and 310, the connection configuration of the storage devices 400 to 403, and a connection configuration between these bridges and storage devices, as indicated by the specific example illustrated in FIG. 1. Further, assume that the content of the response from the device side also indicates the connection configuration among the devices connected to the SATA controller 110, i.e., the bridges 200, 300, and 310, the connection configuration among the storage devices 400 to 403, and the connection configuration of these bridges and storage devices.

If the CPU 101 determines that there is no change between the connection configuration of the bridges and the storage devices at the time of the previous startup and the connection configuration indicated by the content of the response to the IDENTIFY DEVICE command issued in step S701 from the device side (NO in step S703), the processing proceeds to step S706. No change in the connection configuration means that there is no change at all in the connection relationship among the bridges 200, 300, and 310 connected to the SATA controller 110 and the connection configuration of the bridges 300 and 310 and the storage devices 400 to 403 in the specific example illustrated in FIG. 1. In other words, the change in the connection configuration refers to a change in the connection configuration among the bridges or the connection configuration between the bridges and the storage devices, an exchange of at least a part of the storage devices connected to the bridges for each other, a removal of the storage device or an additional connection of a new storage device, and the like. Further, the change in the connection configuration also includes a case in which a part of the storage devices connected to the bridges is replaced with a new storage device.

Thus, when there is no change at all in the connection configuration, the operation mode of each of the bridges 200, 300, and 310 is neither changed.

In step S706, the CPU 101 starts up each of the bridges 200, 300, and 310 while maintaining the configuration and the operation modes at the time of the previous startup, assuming that there is no change at all in the connection configuration of the bridges 200, 300, and 310 connected to the SATA controller 110 and the storage devices 400 to 403. After that, the CPU 101 ends the processing. The CPU 101 may operate so as to end the processing after storing the information acquired in step S702 into the ROM 102 or the like.

On the other hand, if the CPU 101 determines that there is a change between the connection configuration of the storage devices and the bridges at the time of the previous startup and the connection configuration indicated by the content of the response to the IDENTIFY DEVICE command issued in step S701 from the device side (YES in step S703), the processing proceeds to step S705. In step S705, the CPU 101 determines whether there is a change in the connection configuration of the bridges 200 to 310 based on the connection configuration of the storage devices and the bridges at the time of the previous startup and the connection configuration indicated by the content of the response to the IDENTIFY DEVICE command from the device side. The change in the connection configuration of the bridges include a change in a connection arrangement of the bridges (e.g., the cascade connection arrangement illustrated in FIG. 1), a removal of any of the bridges 200, 300, and 310 or an addition of a new bridge (further, including a change in the device connected to the bridge), and the like.

If the CPU 101 determines that there is a change in the connection configuration of the bridges 200, 300, and 310 (YES in step S705), the processing proceeds to step S711.

On the other hand, if the CPU 101 determines that there is no change in the connection configuration of the bridges 200, 300, and 310 (NO in step S705), the processing proceeds to step S708.

In step S708, the CPU 101 determines whether there is a change only in the combination of the bridge and the storage device based on the connection configuration of the storage devices and the bridges at the time of the previous startup and the content of the response to the IDENTIFY DEVICE command. Example of the change only in the combination of the bridge and the storage device include a case in which at least a part of the storage devices 400 to 403 connected to the bridges 300 and 310 is exchanged for each other, and a case in which the bridges 200, 300, and 310 are exchanged for each other. For example, in the configuration illustrated in FIG. 1, this change corresponds to a case in which the storage device 401 (HDD 2) and the storage device 402 (SSD 1) are exchanged for each other, a case in which the bridges 300 and 310 are exchanged for each other, and the like.

If the CPU 101 determines that the change is not a change only in the combination of the bridge and the storage device (NO in step S708), the processing proceeds to step S716. The change that is not a change only in the combination of the bridge and the storage device corresponds to a case in which at least a part of the storage devices 400 to 403 connected to the bridges 300 and 310 is replaced with a new storage device, a case in which a new storage device is added, and the like. In step S716, the CPU 101 issues the initialization processing instruction targeting the storage devices 400 to 403 to each of the bridges 300 and 310 via the SATA controller 110 and the bridge 200, thereby performing the initialization processing. After that, the processing proceeds to step S717.

On the other hand, if the CPU 101 determines that the change is a change only in the combination of the bridge and the storage device (YES in step S708), the processing proceeds to step S709.

In step S709, the CPU 101 notifies each of the bridges 200, 300, and 310 of an inquiry about the current operation mode, the setting information, and the like via the SATA controller 110. Then, the processing proceeds to step S710.

In step S710, the CPU 101 re-sets the mode of each of the bridges 200, 300, and 310 based on the connection configuration information stored in the ROM 102 or the like, the current operation mode and the setting information of each of the bridges 200, 300, and 310 that are contained in a content of a response to the notification of the inquiry from each of the bridges 200, 300, and 310. More specifically, the CPU 101 issues a mode re-setting instruction to each of the bridges 200, 300, and 310 via the SATA controller 110. Thus, the CPU 101 determines the operation mode of each of the bridges 200, 300, and 310 that should be set based on the connection relationship (connection configuration) between each of the bridges 200, 300, and 310 and the storage devices 400 to 403 and the type of each of the storage devices 400 to 403 that have been acquired in steps S702, S703, S705, and S708. Then, if there is a bridge with respect to which the determined operation mode and the current operation mode are different from each other, the CPU 101 re-sets the determined operation mode to this bridge. For the other bridges, the CPU 101 maintain the current operation modes thereof because the operation modes are not changed.

For example, the CPU 101 sets the operation mode and the setting information of the bridge 200 to the bridges 300 and 310, and, conversely, sets the operation mode and the setting information of the bridges 300 and 310 to the bridge 200.

As an example, the CPU 101 changes the operation mode of each of the bridges 300 and 310 if determining that, with respect to each of the bridges 300 and 310, the combination of the types of the storage devices connected thereto (HDD and SSD) is changed from the combination at the time of the previous startup.

For example, in the configuration illustrated in FIG. 1, if the storage device 401 (HDD 2) and the storage device 402 (SSD 1) are exchanged for each other, the types of the storage devices connected to each of the bridges 300 and 310 are changed to the HDD and the SSD, thereby becoming the different types. In the present state, the bridge 200 is in the hybrid mode S503 and the bridges 300 and 310 are each in the mirroring mode S502, and thus mismatch occurs between each of the operation modes of the bridges 200, 300, and 310 and the combination of the exchanged storage devices if the operation modes remain the same.

Thus, the CPU 101 issues the mode re-setting instruction to each of the bridges 200, 300, and 310, thereby setting the operation mode of each of the bridges 300 and 310 so as to change it from the mirroring mode S502 to the hybrid mode S503 and setting the operation mode of the bridge 200 so as to change it from the hybrid mode S503 to the mirroring mode S502. As a result, matching is maintained between each of the operation modes of the bridges 200, 300, and 310 and the combination of the storage devices connected thereto.

Even when the change is a change only in the combination of the bridge and the storage device, the operation mode of each of the bridges 200, 300, and 310 is not changed if the combination of the types of the storage devices connected to each of the bridges 300 and 310 is not changed. For example, if the combination of the storage device 400 (HDD 1) and the storage device 401 (HDD 2) and the combination of the storage device 402 (SSD 1) and the storage device 403 (SSD 2) are exchanged for each other, the storage devices connected to each of the bridges 300 and 310 remain the combination of the same type of storage devices. Therefore, the operation modes are not changed, i.e., the operation mode of each of the bridges 300 and 310 is maintained to the mirroring mode S502, and the operation mode of the bridge 200 is maintained to the hybrid mode S503. As a result, the matching is maintained between each of the operation modes of the bridges 200, 300, and 310 and the combination of the storage devices connected thereto.

After the CPU 101 ends the processing in step S710, the processing proceeds to step S717. In step S717, the CPU 101 stores the changed mode settings and the like into the ROM 102 or the like as the connection configuration information. Then, the CPU 101 ends the processing.

If the CPU 101 determines that there is a change in the connection configuration of the bridges (YES in step S705), the processing proceeds to step S711. In step S711, the CPU 101 determines whether there is a connected device based on the content of the response to the IDENTIFY DEVICE command issued in step S701. In other words, the CPU 101 determines whether there is a connected device beyond the bridge 200 connected to the SATA controller 110.

In step S711, if the CPU 101 determines that there is no connected device beyond the bridge 200 (NO in step S711), the processing proceeds to step S713.

In step S713, the CPU 101 presents an error display on the operation unit 109, indicating that no SATA device can be detected beyond the bridge 200 connected to the SATA controller 110. Then, the processing proceeds to step S717. In step S717, the CPU 101 stores the information such as the connection configuration of the bridges after the change that has been acquired in step S702 into the ROM 102 or the like. Then, the CPU 101 ends the processing.

On the other hand, in step S711, if the CPU 101 determines that there is a connected device beyond the bridge 200 (YES in step S711), the processing proceeds to step S712.

In step S712, the CPU 101 determines whether a SATA device including a bridge is connected to the SATA controller 110 in the cascade manner based on the content of the response to the IDENTIFY DEVICE command issued in step S701.

At this time, configuration examples of the cascade connection include a configuration in which at least two bridges (200 and 300) and a plurality of devices are connected to the controller 110 in the cascade manner. For example, one possible configuration as this example is that at least one storage device and the bridge 300 are connected beyond the bridge 200, and a plurality of devices, such as a plurality of storage devices or at least one storage device and the bridge 310, is connected beyond the bridge 300. In this case, a plurality of devices may be further connected beyond the bridge 310. Further, another example is that the bridge 300 is connected beyond the bridge 200, and a plurality of devices, such as a plurality of storage devices or at least one storage device and the bridge 310, is connected beyond the bridge 300. In this case, a plurality of devices may further be connected beyond the bridge 310.

They are examples of the cascade connection, and the present exemplary embodiment can be applied to such a wide variety of cascade connections.

In step S712, if the CPU 101 determines that no bridge is connected to the SATA controller 110 in the cascade manner (NO in step S712), i.e., determines that only the bridge 200 is connected, the processing proceeds to step S715.

In step S715, the CPU 101 issues the mode re-setting instruction to the bridge 200 via the SATA controller 110, thereby re-setting the operation mode thereof. In other words, the CPU 101 determines the operation mode of the bridge 200 that should be set based on the connection relationship (connection configuration) between the bridge 200 and the storage devices and the type of each of the storage devices that have been acquired in steps S702, S703, S705, and sets the determined operation mode to the bridge 200. At this time, the CPU 101 sets either the mirroring mode S502 or the hybrid mode S503, assuming that the two storage devices belonging to the same type or the different types are connected to the bridge 200.

Needless to say, the CPU 101 may operate so as to re-set the single mode S501 if only one storage device is connected to the bridge 200.

On the other hand, in step S712, if the CPU 101 determines that a bridge is connected to the SATA controller 110 in the cascade manner (YES in step S712), the processing proceeds to step S714. In the present exemplary embodiment, assume that the bridge 200 and the like are connected in the cascade manner in a different connection relationship from FIG. 1.

In step S714, the CPU 101 issues the mode re-setting instruction to the bridge 200 and the like via the SATA controller 110 based on the connected device information indicated by the content of the response to the IDENTIFY DEVICE command, thereby re-setting the operation mode of each of the bridges. In other words, the CPU 101 determines the operation mode of each of the bridges that should be set based on the connection relationship (connection configuration) between each of the bridges and the storage devices and the type of each of the storage devices that have been acquired in steps S702, S703, S705, S711, and S712, and sets the determined operation mode to each of the bridges. Assume that, at this time, the operation modes set to the bridge 200 and the like are both the mirroring mode S502 and the hybrid mode S503. Needless to say, the CPU 101 may operate so as to re-set the single mode S501 if only one storage device is connected to the bridge.

In step S716, the CPU 101 causes the bridge 200 and the like to perform the initialization processing on the connected storage devices 400 to 403 via the SATA controller 110.

Next, in step S717, the CPU 101 stores the information about each of the connected devices connected beyond the SATA controller 110 after the change as the connection configuration information. More specifically, the CPU 101 stores the connection configuration of the bridges and the storage devices after the change, the operation modes and the setting information of the bridge 200 into the ROM 102 or any of the storage devices 400 to 403 and the like as the connection configuration information.

Next, an operation of mode re-setting processing performed by the bridges 200, 300, and 310 will be described with reference to a flowchart illustrated in FIG. 7B. In the present exemplary embodiment, mode re-setting processing performed by the CPU 201 in the bridge 200 will be described as one example, but this processing is also performed by each of the other bridges 300 and 310 in a similar manner.

A program running on the CPU 201 regarding the flowchart illustrated in FIG. 7B may be stored in the RAM 203, the ROM 202, or any of the storage devices 400 to 403.

The processing procedure illustrated in FIG. 7B will be described assuming that this processing is performed at the time of the initialization, for example, the startup in the present exemplary embodiment, but is not limited thereto and may be performed when the CPU 201 accesses the connected SATA device, for example, every time the CPU 201 attempts this access.

First, in step S721, the CPU 201 confirms whether a SATA device is connected beyond the SATA host I/Fs 205 and 206 upon receiving the notification for confirming whether there is a connected device from the host side via the SATA device I/F 204. As a specific example, the CPU 201 issues the ATA command such as the IDENTIFY DEVICE command to the device side via each of the SATA host I/Fs 205 and 206, thereby confirming whether a SATA device is connected.

If there is a response to the IDENTIFY DEVICE command issued in step S721 from the device side (YES in step S722), the CPU 201 determines that a SATA device is connected beyond the SATA host I/Fs 205 and 206. Then, the processing proceeds to step S723.

On the other hand, if there is no response to the IDENTIFY DEVICE command issued in step S721 from the device side (NO in step S722), the CPU 201 determines that no device is connected to the SATA host I/Fs 205 and 206, and the processing proceeds to step S724.

In step S723, the CPU 201 determines whether the error notification indicating that no device is connected to the SATA host I/Fs 205 and 206 is contained in the response to the IDENTIFY DEVICE command issued in step S721 from the device side.

In step S723, if the CPU 201 determines that the error notification is contained in the response to the IDENTIFY DEVICE command from the device side (YES in step S723), the processing proceeds to step S724.

On the other hand, in step S723, if the CPU 201 determines that the error notification is not contained in the response to the IDENTIFY DEVICE command from the device side (NO in step S723), the processing proceeds to step S725.

In step S724, the CPU 201 notifies the host side that the current state is such an error state that no device is connected to the SATA host I/Fs 205 and 206. In response to this notification, the main controller 100 presents the error display on the operation unit 109, indicating that no device is connected to the SATA host I/Fs 205 and 206. After that, the CPU 201 ends the processing. The processing may proceed to step S733 instead of being ended, and the CPU 201 may operate so as to store the information about the connected device that has been acquired in step S722 into the ROM 202 as the connection configuration information.

In step S725, the CPU 201 acquires the connected device information by merging the content of the response to the IDENTIFY DEVICE command issued in step S721 and the information about the bridge 200 itself. In step S725, the CPU 201 further notifies the host side of the connected device information via the SATA device I/F 204. Then, the processing proceeds to step S726.

In step S726, the CPU 201 compares the content of the response to the IDENTIFY DEVICE command issued in step S721 from the device side and the connection configuration at the time of the previous startup that has been stored in the ROM 202 during the initialization processing illustrated in FIG. 6B. The connection configuration and the like at the time of the previous startup refers to the connection configuration of the storage devices 400 to 403 and the bridges 200, 300, and 310.

If the CPU 201 determines that there is no change between the connection configuration of the bridges and the storage devices at the time of the previous startup and the content of the response to the IDENTIFY DEVICE command issued in step S721 (NO in step S726), the processing proceeds to step S733. In step S733, the CPU 201 stores the information about the connected devices that has been acquired in step S722 into the ROM 202 as the connection configuration information. The CPU 201 may operate so as to end the processing instead of the processing proceeding to step S733.

Here, the change in the connection configuration refers to a change in the connection configuration among the bridges or the connection configuration between the bridges and the storage devices, an exchange of at least a part of the storage devices connected to the bridges for each other, a removal of the storage device or an additional connection of a new storage device, and the like. Further, the change in the connection configuration also includes, for example, a case in which a part of the storage devices connected to the bridges is replaced with a new storage device.

On the other hand, if the CPU 201 determines that there is a change between the connection configuration of the storage devices and the bridges at the time of the previous startup and the content of the response to the IDENTIFY DEVICE command issued in step S721 (YES in step S726), the processing proceeds to step S728.

In step S728, the CPU 201 determines whether the change is a change only in the combination of the bridge and the storage device based on the connection configuration of the storage devices and the bridges at the time of the previous startup and the content of the response to the IDENTIFY DEVICE command issued in step S721. Examples of the change only in the combination of the bridge and the storage device include a case in which at least a part of the storage devices 400 to 403 connected to the bridges 300 and 310 is exchanged for each other, and a case in which the bridges 200, 300, and 310 are exchanged for each other.

If the CPU 201 determines that the change is a change only in the combination (YES in step S728), the processing proceeds to step S729.

On the other hand, if the CPU 201 determines that the change is not a change only in the combination (NO in step S728), the processing proceeds to step S731. The change that is not a change only in the combination of the bridge and the storage device corresponds to a case in which at least a part of the storage devices 400 to 403 connected to the bridges 300 and 310 is replaced with a new storage device, a case in which the storage device is removed, and a case in which a device such as a new storage device is added.

In step S729, the CPU 201 receives the notification of the inquiry about the operation mode, the setting information, and the like to each of the bridges 200, 300, and 310 that has been transmitted from the main controller 100 in step S709. Further, in step S729, the CPU 201 notifies the bridges 300 and 310 of the inquiry about the operation mode, the setting information, and the like to the bridges 300 and 310 via the SATA host I/Fs 205 and 206. Further, the CPU 201 acquires the information about the connected devices by merging the content of the response to the inquiry about the operation mode, the setting information, and the like to the bridges 300 and 310 from each of the bridges 300 and 310, and the operation mode and the setting information of the bridge 200 itself. Then, the CPU 201 notifies the host side of the connected device information via the SATA device I/F 204. Then, the processing proceeds to step S731.

In step S731, the CPU 201 receives the mode re-setting instruction, which has been the response to the connected device information in step S714 or S715, from the host side via the SATA device I/F 204. Further, in step S731, the CPU 201 identifies the content of the mode setting instruction addressed to the bridge 200 itself and the contents of the mode setting instructions addressed to the devices connected to the SATA host I/Fs 205 and 206 from the received mode setting instruction from the host side. Further, the CPU 201 notifies the bridges 300 and 310 of the identified contents of the mode re-setting instructions addressed to the devices connected to the SATA host I/Fs 205 and 206 (bridges 300 and 310 in FIG. 1) via the SATA host I/Fs 205 and 206. With this notification, the operation modes of the bridges 300 and 310 are re-set. Further, the CPU 201 sets the operation mode of the bridge 200 itself based on the identified mode setting instruction addressed to the bridge 200. Then, the processing proceeds to step S732.

In step S732, the CPU 201 receives the re-initialization processing instruction targeting the storage devices from the host side (S716) via the SATA device I/F 204. Further, in step S732, the CPU 201 notifies the devices connected to the SATA host I/Fs 205 and 206 of the received re-initialization processing instruction, thereby performing the initialization processing on the storage devices. Then, the processing proceeds to step S733.

In step S733, the CPU 201 stores the operation modes of the bridge 200 and the like re-set in step S731, the information about the connected devices confirmed in step S721, and the like into the ROM 202 as the connection configuration information.

In this manner, the mode re-setting processing by the bridge 200 is completed.

The initialization processing is also performed by the other bridges 300 and 310 connected to the bridge 200 in a similar manner.

As described above, the storage system according to the present exemplary embodiment includes a controller (110), a first bridge (200) connected to the controller, and a second bridge (300) and a third bridge (310) connected to the first bridge. Further, the storage system includes a plurality of storage devices (400 to 403) each connected to any of the first to third bridges. At least one of the controller and the first to third bridges includes a storage unit (102, 202, 302, or 312), a determination unit (steps S703 to S708 and S728), and a re-setting unit (steps S710, S714, and S731). The storage unit stores information including a connection configuration of the first to third bridges and the storage devices. The determination unit determines based on the information stored in the storage unit whether the connection configuration of the first to third bridges and the plurality of storage devices connected thereto is changed from the connection configuration at the time of a previous operation (at the time of initialization, for example, a startup or at the time of access to the device). If the determination unit determines that the connection configuration is changed, the re-setting unit re-sets an operation mode of each of the first to third bridges based on this change in the connection configuration.

Therefore, according to the present exemplary embodiment, if the connection configuration of the bridges connected in the cascade manner and the plurality of storage devices connected beyond that is changed from the connection configuration at the time of the operation such as the previous startup, the operation mode of each of the bridges is re-set based on this change. As a result, even when there is a change in the connection configuration, such as connecting the storage device by exchanging it from the connection configuration at the time of the operation such as the previous startup, the mismatch can be prevented between the operation mode of the bridge and the storage device connected to this bridge, and the storage system can normally continue the operation.

Further, even when the connection configuration of the bridges, and the plurality of storage devices connected to the bridges are changed from those at the time of the operation such as the previous startup, the operation mode of each of the bridges is also re-set based on this change. Therefore, the storage system can further flexibly handle the change in the connection configuration.

The processing procedures illustrated in the flowcharts of FIGS. 6A and 7A are assumed to be performed by the CPU 101 in the main controller 100, but may be set so as to be performed by a CPU prepared in the SATA controller 110.

Further, a control apparatus to which a nonvolatile storage device including a semiconductor memory and a nonvolatile storage device including a disk can be connected, or a control method therefor (110, 200, or 300) according to another embodiment of the present disclosure includes a setting unit configured to set an operation mode or setting steps (steps S710, S714, and S731) for setting an operation mode. The setting unit (setting steps) sets a predetermined operation mode set based on connections of the nonvolatile storage device including the semiconductor memory and the nonvolatile storage device including the disk to the control apparatus. Further, if a plurality of the storage devices each including the semiconductor memory is connected to the control apparatus and the nonvolatile storage device including the disk is not connected to the control apparatus, the setting unit (setting steps) sets an operation mode regarding mirroring that is different from the predetermined operation mode, in which the plurality of connected nonvolatile devices is mirrored. Similarly, if the storage device including the semiconductor memory is not connected to the control apparatus and a plurality of the nonvolatile storage devices each including the disk is connected to the control apparatus, the setting unit (setting steps) sets the operation mode regarding the mirroring that is different from the predetermined operation mode.

### OTHER EMBODIMENTS

The present invention can also be embodied by processing that supplies a program for implementing one or more functions of the above-described exemplary embodiment to a system or an apparatus via a network or a storage medium, and causes one or more processors in a computer of this system or apparatus to read out and execute the program. Further, the present invention can also be embodied by a circuit (e.g., an application specific integrated circuit (ASIC)) for realizing one or more functions.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the scope of the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-041887, filed Mar. 8, 2018, which is hereby incorporated by reference herein in its entirety.

What is claimed is:

1. A storage system, comprising:
a controller;
a first bridge connected to the controller;
a second bridge and a third bridge connected to the first bridge;
a plurality of storage devices each connected to the second bridge or the third bridge;
a memory configured to store information including a connection configuration of the plurality of storage devices;
a determination unit configured to determine whether the connection configuration of the plurality of storage devices has been changed, based on the information stored in the memory; and
a re-setting unit configured to re-set at least one of an operation mode of the first bridge, an operation mode of the second bridge, or an operation mode of the third bridge based on the connection configuration after the change, based on the determination that the connection configuration has been changed.

2. The storage system according to claim 1,
wherein each of the plurality of storage devices is a first type storage device or a second type storage device,
wherein the memory stores the type of each of the plurality of storage devices as part of the information, and
wherein the determination unit determines whether a subset of the plurality of storage devices which is connected to the second bridge is comprised of the same type of storage devices or different types of storage devices and whether a subset of the plurality of storage devices connected to the third bridge is comprised of the same type of storage devices or different types of storage devices.

3. The storage system according to claim 2, wherein the first type storage device is a storage device storing data not requiring a higher access speed, and the second type storage device is a storage device storing data requiring a higher access speed.

4. The storage system according to claim 2,
wherein the re-setting unit re-sets the operation mode of the second bridge and the operation mode of the third bridge to be a first operation mode in a case where the subset of storage devices connected to the second bridge is determined to be comprised of the same type of storage devices, and the subset of storage devices connected to the third bridge is determined to be comprised of the same type of storage devices, and
wherein the re-setting unit re-sets the operation mode of the second bridge and the operation mode of the third bridge to be a second operation mode in a case where the subset of storage devices connected to the second bridge is determined to be comprised of different types of storage devices and the subset of storage devices connected to the third bridge is determined to be comprises of different types of storage devices.

5. The storage system according to claim 4, wherein the first operation mode is a mirroring mode, and the second operation mode is a hybrid mode.

6. The storage system according to claim 2,
wherein the determination unit issues a notification for confirming the connection configuration of the storage devices to each of the first, second and third bridges, and determines whether the connection configuration of the storage devices has been changed from a state before the system was started up, based on a content of a response to the notification for confirming the connection configuration of the storage devices, received from each of the first, second and third bridges, and
wherein the re-setting unit issues, in a case where the connection configuration of the storage devices is determined to have been changed, a notification for confirming the operation mode to each of the first, second and third bridges, and re-sets the operation mode of each of the first, second and third bridges based on a content of a response to the notification for confirming the operation mode, from each of the first, second and third bridges.

7. The storage system according to claim 2,
wherein the determination unit issues a notification for confirming a storage device connected to other bridges to each of the other bridges, and determines whether the connection configuration of the first, second and third bridges has been changed from the connection configuration at the time of a previous operation, based on the information stored in the memory and a content of a response to the notification for confirming the device, from each of the other bridges, and
wherein the re-setting unit issues, in a case where the determination unit determines that the connection configuration has been changed from the connection configuration at the time of the previous operation, a notification for confirming the operation mode to each of the other bridges, and re-sets the mode of each of the first, second and third bridges based on a content of a response to the notification for confirming the operation mode, from each of the other bridges.

8. A storage system, comprising:
a controller;
at least first and second bridges;
a plurality of devices connected to the controller in a cascade manner;
a memory configured to store information including a connection configuration of the first and second bridges and the plurality of devices;
a determination unit configured to determine whether the connection configuration of the first and second bridges and the plurality of devices has been changed from the connection configuration at the time of a previous operation, based on the information stored in memory; and
a re-setting unit configured to re-set an operation mode of each of the first bridge and the second bridge to correspond with the connection configuration after the change in the connection configuration, in a case where the determination unit determines that the connection configuration has been changed.

9. The storage system according to claim 8, wherein the plurality of devices includes a storage device.

10. A control apparatus to which a nonvolatile storage device including a semiconductor memory and a nonvolatile storage device including a disk can be connected, the control apparatus comprising:
a setting unit configured to set a predetermined operation mode based on connections of the nonvolatile storage device including the semiconductor memory and the nonvolatile storage device including the disk, to the control apparatus, and
set an operation mode regarding mirroring that is different from the predetermined operation mode, in which the plurality of connected nonvolatile devices is mirrored, in a case where a plurality of the storage devices each including the semiconductor memory is connected to the control apparatus and the nonvolatile storage device including the disk is not connected to the control apparatus, or in a case where the storage device including the semiconductor memory is not connected to the control apparatus and a plurality of the nonvolatile storage devices each including the disk is connected to the control apparatus.
